(19) United States
(12) Patent Application Publication
(10) Pub. No.: US 2016/0210714 A1
(43) Pub. Date: Jul. 21, 2016

(54) METHOD FOR STORING MEDICAL IMAGES AND IMAGING SYSTEM THEREOF

(71) Applicant: EBM TECHNOLOGIES INCORPORATED, TAIPEI CITY (TW)

(72) Inventor: WILLIAM PAN, TAIPEI CITY (TW)

(21) Appl. No.: 14/600,341

(22) Filed: Jan. 20, 2015

(51) Int. Cl. G06T 1/00; G06T 7/00

(52) U.S. Cl. CPC G06T 1/0007; G06T 7/0081; G06T 2207/10012

(57) ABSTRACT

Disclosure is related to a method for storing medical images, and a related imaging system. The system retrieves a series of original image data of an organism body from a medical modality. A three-dimensional image can be reconstructed from the image data and allowing an operator to process reviewing. The system then collects operating signals from the process of reviewing. One or more images of critical profile can be determined based on the operating signals. After that, image information respectively associated with the images of critical profiles and non-critical profiles is obtained for rendering different tactics for separately storing the images of the critical and non-critical profiles. For example, the images for the critical profiles are stored as the original images; and the images for the non-critical profiles are stored using a streamlined scheme. The storing method effectively reduces the storage space.

### BACKGROUND OF THE INVENTION

1. Field of the Invention

The present invention is generally related to a method and system for storing medical image; more particularly, to an intelligent method and system for storing the medical image with reduced storage space.

2. Description of Related Art

Medical imaging is to form biological images produced by the medical equipment through diagnosis or medical activity. The biological images may be used to diagnose certain diseases. The biological images may also be used for medical research, such as developing non-invasive imaging method to capture images of all or part of internal tissues. The images produced by the medical imaging system are such as the images made by ultrasound scanning machine, magnetic resonance imaging (MRI) system, positron emission tomography (PET) system, computed tomography (CT) system, Mammography technology, and X-ray photography machine.

A picture archiving and communication system (PACS) is a computer system employed to process, store, print, transmit, and show the digitized medical images. PACS is in compliance with international standard of DICOM (Digital Imaging and Communications in Medicine).

For providing high resolution and high quality images, the PACS for the purpose of diagnosis requiring a great of storage space. To the above mentioned medical images produced by the various medical modalities, the traditional technology lacks of practical and effective solution for storage in addition to the conventional compress method for reducing storage.

### SUMMARY OF THE INVENTION

For providing a solution to effectively store the medical images, the disclosure relates to a method for storing medical images and a system thereof. The method in accordance with a tactic is to fully store the images of interested portions. Otherwise, the rest portion is stored in accordance with a streamlined scheme. By this scheme, the storage space can be effectively saved since the method is only to store the original images of the interest portion. Further, the scheme allows saving time to invalidly access, browse and handle the uninterested portion of images. In particular, the method is able to provide personalized use according to the personal operations and habits. In which, the signals related to the personal operations are the references to discern what are the interested portions according to one of the embodiments.

The intelligent method is able to save the storage space for the medical images. In the method, the original images produced by a medical modality are firstly received. The images made by the medical modality are exemplified by the organism body. These original images may be used to reconstruct the three-dimensional image of the organism body. The 3D image is provided for an operator to preview the organism body. Then the operation signals can be generated when the operator manipulates the medical machine to conduct previewing procedure over the three-dimensional image. The operation signals are referred to determine one or more critical profiles from the three-dimensional image. Simultaneously, the critical and non-critical portions are discerned. Therefore, the system gains the image information from the critical profiles and otherwise from the non-critical profiles.

Next, the system separately stores the original images associated with the one or more critical profiles, and the processed images for the non-critical profiles according to a tactic of storing. The tactic is such as a rule to configure the ranges for the critical profiles and non-critical profiles respectively.

Before reconstructing the three-dimensional image, the system checks if any malposition is found by referring to a positioning image. In an exemplary example, one or more directional profile images are retrieved from the original image of an organism body, by which the profile images may be used to check the alignment of the reconstructed three-dimensional image.

For an example of a medical image storage system, the system includes an image input module coupled to at least one medical modality for capturing the original image from the medical modality. The system has an original image storing module used to store the original image of the organism body. The system further includes an image reconstruction module used to reconstruct a three-dimensional image for the original image retrieved from the organism body. The system includes a preview module providing an operating interface for the user to preview the three-dimensional image. The system includes an operation signal retrieval module allowing retrieving operation signals when the user manipulates the operation module to preview the 3D image. Further, the system includes a critical profile recording module. The critical profile recording module determines one or more critical profiles within the three-dimensional image in response to the operation signals. Furthermore, one or more non-critical profiles may be obtained as excluding the critical profiles. The system also includes a storage computing module. When the image information associated with the one or more critical profiles and to the one or more non-critical profiles is obtained, the original images associated with the critical profiles as well as the processed images associated with the non-critical profiles can be produced. After that, image output module outputs the original images associated with the critical profiles and the processed images for the non-critical profiles. The original images and the processed images may be stored in a data library.

In one embodiment, the medical image storing system includes positioning a positioning image generating module, and a malposition examining module for examining if any malposition occurred to the reconstructed three-dimensional image.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram showing an application of the system for storing medical image with a MRI of radiology department;

FIG. 2A and FIG. 2B are schematic diagrams depicting the three-dimensional images produced by the medical modality;

FIG. 3 shows a flow chart illustrating the method for storing medical images according to one of the embodiments of the present invention;

FIG. 4 shows a flow chart illustrating steps of determining the operating actions in the method of the present invention;

FIG. 5 shows a flow chart illustrating steps of storing images of critical profiles in the method for storing the medical image in one embodiment of the present invention;

FIG. 6 shows a flow chart illustrating steps of storing the images associated with the non-critical profiles in the method of the present invention;

FIG. 7 shows a block diagram depicting the system in one embodiment of the present invention;

FIG. 8 shows a schematic diagram depicting circumstance for storing the corresponding images associated with the critical and non-critical profiles in the method of the present invention.

### DETAILED DESCRIPTION OF THE PREFERRED EMBODIMENTS

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In an exemplary embodiment of the present invention, the disclosure is related to a method for storing medical images, and a system for implementing the method. The system renders a solution for effectively storing the medical images which requires huge capacity. In an aspect of the invention, the medical images are classified to a critical portion which requires complete storing scheme, and the rest are the non-critical portion requiring a kind of streamlined storing scheme. When the images are separately stored with the respective storing schemes according to their attributes, the storage space can be effectively reduced.

In one embodiment, the method and the system may be applicable to the need to store the big-sized and numerous medical images. For example, some medical facilities such as the modalities conducting Magnetic Resonance Imaging (MRI), Positron Emission Tomography (PET), and Computed Tomography (CT) which are capable of generating the huge medical images. The various applications of the medical images are not repeated herein.

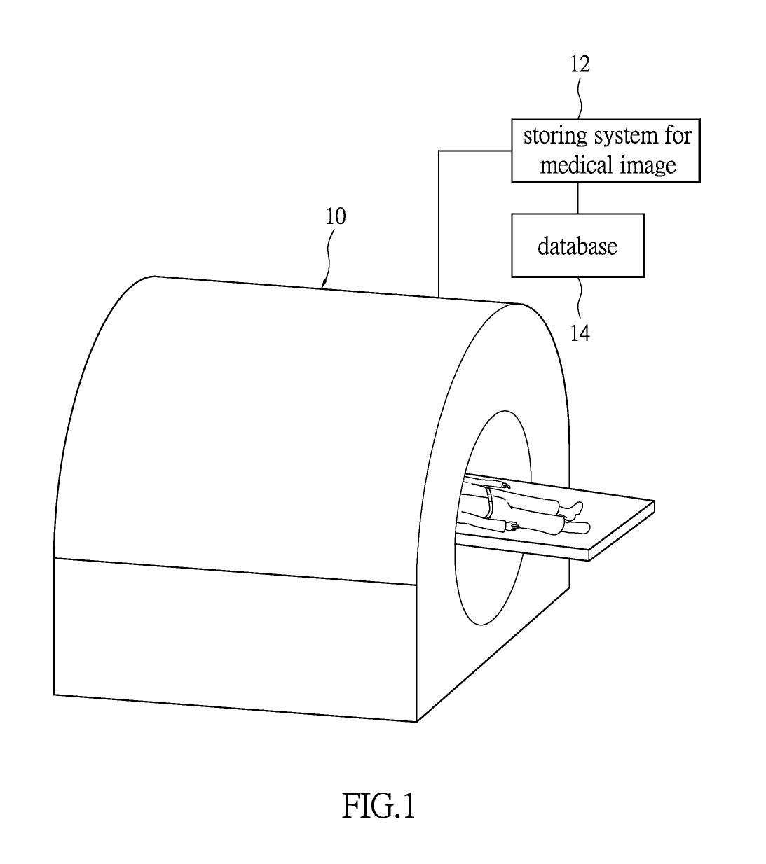

Reference is made to FIG. 1 schematically showing the practical circumstance of the MRI instrument in radiology department and the system of the present invention.

A system 12 for storing the medical images is provided. One end of the system 12 is connected with a medical modality 10. The medical modality 10 may be, but not limited to, the medical facility used to generate various image signals. The medical facility is exemplified by the MRI instrument, Positron emission tomography machine, or CT machine

The other end of the system 12 is connected with a database 14. This database 14 may be a regular file database, or the picture archiving and communication system (PACS) conventionally used to be storage provided for accessing. The major objective of PACS is to store the medical images provided by the system 12 in accordance with the present invention, and the medical images are particularly indexed with the patients and the medical records.

For reviewing the details, the medical images provided for medical personnel to make diagnosis are always stored with the high-resolution quality. For example, the original raw data without compression is stored. However, the raw data occupies huge storage space when the original images are never reduced. According to the embodiment of the present invention, the system 12 for storing medical images chooses the critical images to be completely stored when it receives the original images captured by the medical modality 10. The storing tactic made by the system 12 meets the need of the medical personnel and effectively reduces the requirement of space when the system 12 firstly assesses the critical profiles.

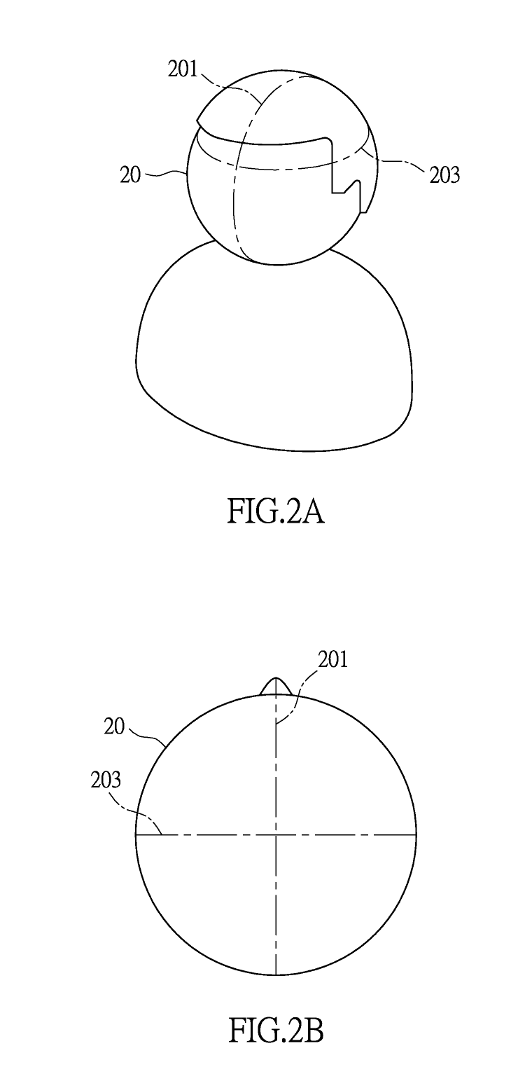

When performing the method for storing the medical images, the system is required to gain the reconstructed images for a longitudinal profile and a transverse profile. The profiles are obtained by scanning the organism body. The longitudinal profile is such as a first profile 201 shown in FIG. 2A. The transverse profile is such as a second profile 203 shown in FIG. 2A. The longitudinal profile or the transverse profile is referred to image positioning for multi-planar reconstruction (MPR).

In an exemplary example, when the storing system 12 for medical image captures the original images of an organism body, a three-dimensional image of the organism body can be reconstructed. The reconstructed image is provided as reference for the medical personnel. The storing system 12 for medical image retrieves the positioning image firstly from the original images. The positioning image is used to check if the reconstructed image meets malposition or other error. References are made to FIG. 2A and FIG. 2B showing the schematic diagram depicting the three-dimensional image obtained from the medical modality. In which the dotted line indicates the cross section (the profile) at the other side.

In FIG. 2A, it shows two profile images with respect to a sagittal first profile 201 and a transverse second profile 203 of a head 20. The two profiles may indicate a longitudinal profile and a transverse profile of a human body or a portion of the body. The two profiles may acts as positioning images for aligning the multiple scanned images. Further, in FIG. 2B, the top view of a head shows two profile lines in two directions. The two profiles may include a sagittal first profile 201 and a coronal profile (not shown).

Therefore, the above-mentioned one or more profile images act as positioning matter for reconstruction. When the reconstructed image errors in alignment, it appears the relevant instrument meets malfunction, or any shift occurs in the process of scanning the organism body. It requires re-scanning the organism body if any malposition or misalignment is found among the layers. It is noted that the positioning profile is not limited to any number or the shown shapes such as sagittal, transverse, or coronal. The number of positioning profiles can be increased or decreased. Further, the position of the right or left, the top or bottom, and the deep or shallow of the positioning profile may also be changed.

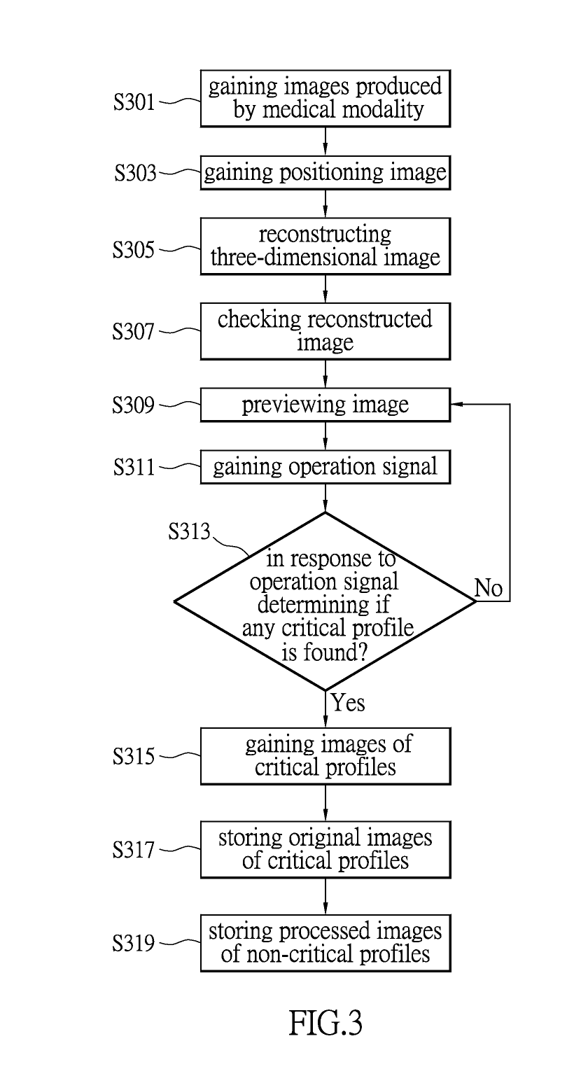

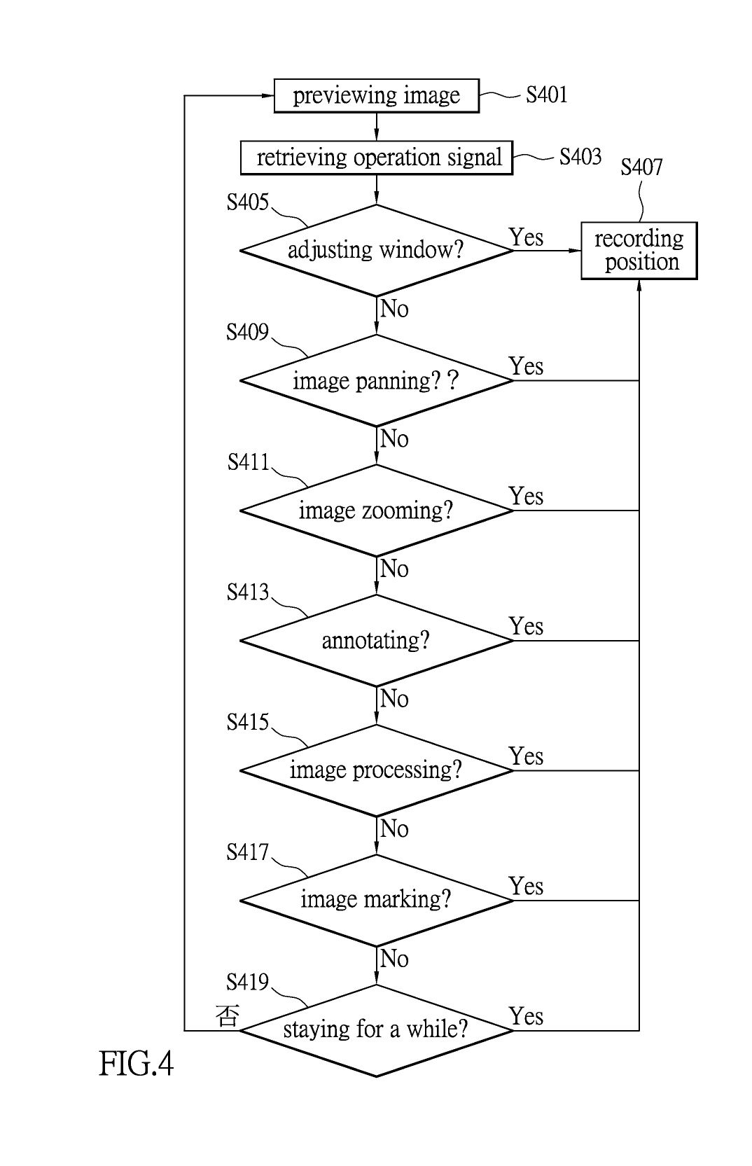

FIG. 3 shows a flow chart illustrating the method for storing medical image in one embodiment of the present invention.

In the beginning of the method, such as step S301, an operator, e.g. the technical staff in a radiology department, operates a medical modality to capture medical images of a specific organism body. The medical images produced by the medical modality are such as tomography scanning images, magnetic resonance scanning images, or a sequence of images produced by the other medical modality. The system in accordance with the disclosure gains the original images of the organism body from the medical modality. The original images are a series of images captured from the body.

In the meantime, in one embodiment, such as step S303, the system acquires a positioning image from the original images. Refer to FIG. 2A, the one or two profile images in a specific direction acts as reference to check the reconstructed image. It is noted that the profile image is the cross section with sagittal surface, transverse surface, coronal surface or the cross section in the other direction.

Next, in step S305, the storing system reconstructs a three-dimensional image for preview according to the original images. The system initially obtains the original images, for example the multi-planar images. The reconstruction forms multi-planar images for the organism body through an initial image processing procedure. This initial image processing procedure allows layer-by-layer retrieving the medical images for reconstructing the 3D image for whole or part of the organism body.

The one or more positioning images including the profile images in different directions is used to check the reconstructed image, such as step S307. For example, the positioning images act as reference to check if the reconstructed image meets malposition or any error. It is possible to re-capture the images of the organism body if any malposition is found. However, the step for generating the positioning images for examining the reconstructed image may be optional as it is ignorable in the process of reconstruction.

A specific professional operator manipulates previewing operations upon the checked or unchecked images, such as step 309. The previewing operations are made before the images are stored, or diagnosis. The operator can preview the reconstructed image and find out the interested portion according to his professional judgment. The previewing operations are one of the important steps to decide a storing tactic according to the present invention.

The operator conducts previewing the layers of profile images of the reconstructed 3D image using a software program executed in a computer system. During the previewing process, operation signals are generated according to the operations made by the operator. Such as step S311, the system receives the operation signals as the operator previewing the three-dimensional image.

It is worth noting that, when the operator conducts image previewing, the system determines if the previewed portion is the critical portion according to the operation signals generated by performing an operation onto any single image. That means the operation signals act as reference to define the critical portion or the non-critical portion. Previewing software initiates an operating interface with various operating tools. The operation signals are based on the operator's various operations through the operating interface. The operations upon the profiles images are such as adjusting window, image panning, image zooming, annotating, image management, key noting, or staying at a previewed image for a while. It is noted that a threshold may be set to define the staying time.

The above-mentioned operations may not limit the scope of the invention. In one embodiment, the system provides further mechanism for manual management to modify the critical profiles determined by the system automatically. The critical profiles may be part of the interested portions of a series of images. The part may have one or more images.

After that, the system finds out one or more critical profiles from the one or more images sliced from the 3D image according to the operation signals, such as in step S313. The critical profiles may include multiple images within a certain range of the organism body. In the process of previewing the 3D image, the step of previewing such as in step S309 may be repeated as in step S309 when none of operation signals is verified.

When the system identifies any operating signal is in compliance with one of the pre-defined operational actions, the system automatically marks the corresponding image(s). Such as in step S315, the related portion of the organism body is configured to be a critical profile, including one or more the corresponding images. The system retrieves the images with respect to the critical profile.

The operator's operations generate the operation signals which act as the reference to identify the critical profiles. The system regards the operator's operations as the meaningful actions correlative with the interested portions during the previewing process for the operator is such as the technical staff in radiology department who always focuses on the interested portions. In other words, the system defines the critical profiles as the meaningful and interested portions of the organism body based on the operator's operations in the previewing process. Rather, the rest portions are non-critical profiles. The every critical profile or non-critical profile correlates with serial images in a range.

In an exemplary example, when the system identifies a critical profile according to the operation signals, the corresponding original images within a storing range are selected to be stored. The critical profile is configured to include the original images within an N-centimeter range around the image corresponding to the operational action. The system outputs the series of original images within the N-centimeter range, for example to the PACS. Furthermore, according to one other storing tactic, the critical profile may be correlative with N images. That means the system will save N original images for the critical profile is identified. In practice, the organism body may include multiple critical profiles, and each critical profile correlates with the images over a certain range. The critical profile is with respect to a complete storing portion. The non-critical profile is correlative with one or more streamlined storing portions. The non-critical profile is also configured to include a series of images covering a range, a width or a number. The system adopts two respective strategies to store the images with respect to the critical and non-critical profiles.

For the critical profiles, the system stores the original images according to the image information associated with the one or more critical profiles, such as in step S317. When one critical profile and one next critical profile are found as the previewing process goes on, the range between the adjacent critical profiles is regarded as a non-critical profile. The every non-critical profile corresponds to a series of images covering a range. The system stores the images associated with the every non-critical profile according to the image information with respect to the non-critical profile. It is noted that the images associated with the non-critical profiles are stored in the system though an image processing process, such as step S319.

When the system retrieves the one or more critical profiles and non-critical profiles for whole or part of the organism body, the storing ranges respective to the critical profiles and non-critical profiles are determined. If a non-critical profile covers too large range of the organism body, the critical profile may be segmented to multiple storing ranges of the correlative images. Every storing range has a series of images which are preliminarily processed and stored in segments. The image processing process may adopt a streamlined scheme for computing an average from a series of images correlative to the every non-critical profile. Further, the streamlined scheme may be a compression procedure performed on the images for storing.

Reference is made to FIG. 4 for describing the system in one embodiment automatically determining the critical profiles according to the operation signals as previewing the images. The steps in the method for storing medical images in accordance with the present invention are as follows.

When the system has reconstructed the image for whole or part of the organism body, the operator for medical modality, such as the staff works in radiology department, may conduct a preliminary previewing. One of the objectives of the preliminary previewing is to check the images, and find out an interested portion. The system and the method assume that the portions where the operator operates on are the interested portions associated to the critical profiles. The operations are such as the operator using preview software to check the medical image of an organism body. When the operator finds out an interest portion as previewing the image, a specific previewing operation is made by the operator. The description to the operations is, but not limited to, as follows. The defined operations may also be changed as demands.

In the beginning, such as in step S401, the operator initiates previewing software to preview the image. The system simultaneously receives the operation signals, such as in step S403. The operation signals associated to the various previewing operations may be set in advance for corresponding to the critical profiles. A software program is executed in the system for checking if any output operation signal is in compliance with the preset operation.

In step S405, the system determines if consecutive operation signals indicate the operation for adjusting the preview window. That means the operation signals may be regarded as the meaningful operation when the operator adjusts a preview window to view the image. Then the corresponding portion is configured to be a critical profile automatically. In step S407, the system records the position with respect to the critical profile.

When the operation signals do not indicate adjusting window, the steps go to determine if the operation signals indicate the operation for image panning, such as in step S409. When the operator uses image panning function to preview the images with respect to a specific portion, the portion may be regarded as a critical profile. The system also records the position thereto, such as in step S407.

When the operation signals are not indicative of the mentioned adjusting window or image panning, the steps further determine if any image zooming action is performed. If the image zooming action is detected, such as step in step S411, the system sets the corresponding portion to be a critical profile and also records the position, such as in step S407.

Further, when there is not yet any meaningful operation to be detected, the steps go to determine if the operator inserts any text or annotation to a part of the image. If any annotation is found, such as in step S413, the corresponding portion is set as a critical profile, and the corresponding position is recorded, such as step S407.

Similarly, if the system fails to find out any of the above meaningful operations, the system goes on determining if any image processing is performed, such as in step S415. If any image processing is found during the previewing process, such as in step S407, the corresponding position is recorded.

Further, if the system fails to detect any meaningful operation, the system determines if the operator marks an image as previewing the body image, such as in step S417. If the system finds out the operator uses the previewing program to mark any image, the system regards the related portion as a critical profile. The position is also recorded in the system, such as in step S407.

Otherwise, the system goes on determining if the operator uses the previewing software to stay at a specific portion for a period of time exceeding a threshold, such as in step S419. When the stay is exceeding the threshold set by the system, the system regards the portion as a critical profile, and also records the corresponding position, such as in step S407.

That means, if the system acknowledges the operator operates one of the above-mentioned operations upon a body portion, the system will set the corresponding portion as a critical profile. The position with respect to the critical profile is also recorded. If there is no any meaningful operation being detected in this previewing stage, the system goes on next portion determination, and the steps go back step S401.

The above-mentioned operations are not only the references to make the determination of critical profiles, but also possibly referring to others.

Even though the system uses the automatic process to determine the operations made by the operator, some other schemes may be incorporated to confirm the determination. The system allows the operator to manually cure the deficiency. For example, the operator manually adds the critical profiles, deletes the critical profile determined by the system in automatic steps. The final output is the actual critical profiles.

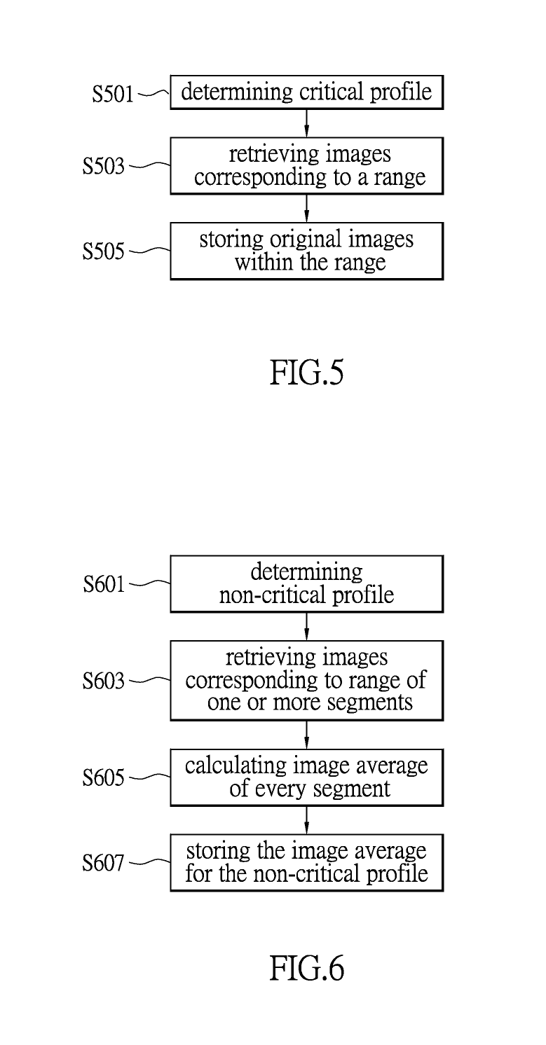

FIG. 5 shows a flow chart describing the steps for storing the images with respect to the critical profiles in the method of the present invention.

When the system finds out the critical profiles, such as in step S501, the system retrieves the images in a range with respect to every critical profile, such as in step S503. To the critical profiles, according to storing tactics, the original images therefor are stored, such as step S505. However, the other types of images, rather than the original images, may also be stored for the critical profile only if the storing tactic still provides high quality image for medical diagnosis.

Next, FIG. 6 shows a flow chart depicting the steps for storing the non-critical profiles in the method of the present invention.

In step S601, the system determines the non-critical profiles as excluding the critical profiles. One non-critical profile may have one or more segments in the correlative range. In step S603, the system may regard the non-critical profile in segments. That is, the system stores the images in segments for the non-critical profile especially the non-critical profile may cover many consecutive portions of the body image. For less images may fail to represent the non-critical profile, the portion for the non-critical profile may be segmented into segments. It is noted that the portions regarded as the non-critical profiles when the critical profiles do not cover the portions, therefore the non-critical profile may cover too broad range. Every segment is defined with a reasonable range, and each segment of the non-critical profile includes at least one representative image.

In step S605, the system calculates an average for the images in every segment, for example to gain an average from a plurality of images within a certain range. The system then stores or outputs the image average for every segment, such as in step S607.

It is noted that the average may be replaced with other type of numerical value. One major objective is to obtain one or more images representative of the critical profiles having the plurality of layers of images. The representative images may not have too much distortion even the images undergo an image processing.

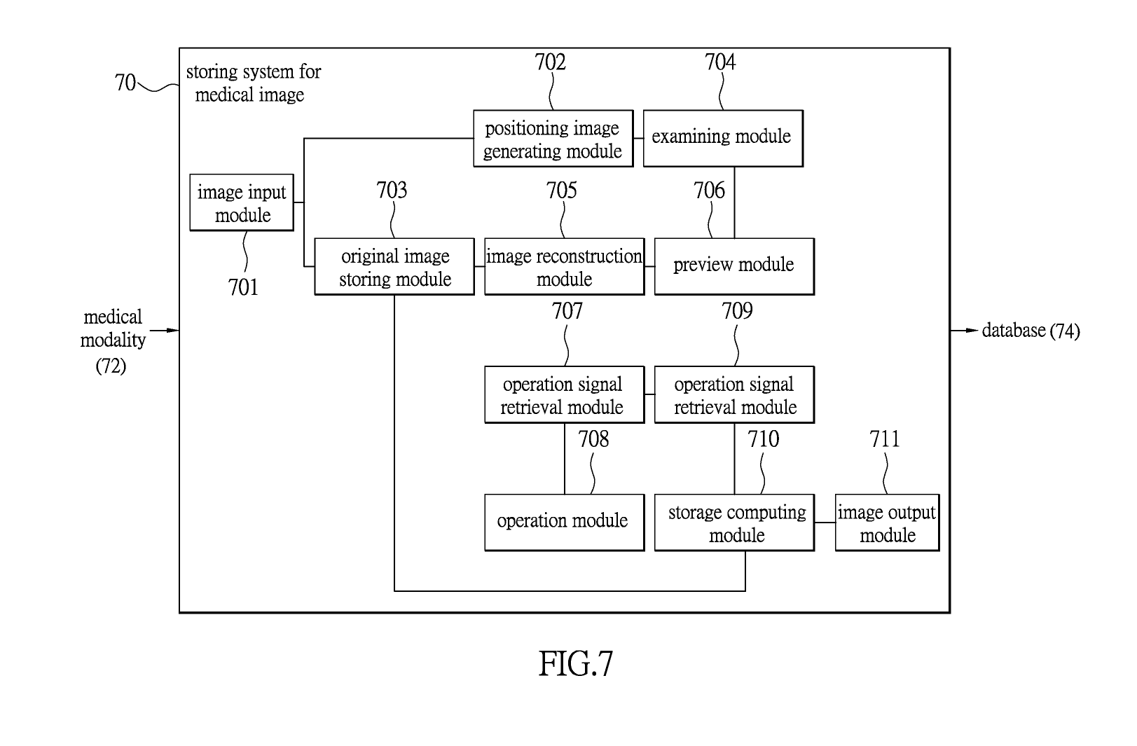

The mentioned system can be implemented by software modules which are applicable to embody the method for storing the medical images. FIG. 7 further depicts the block diagrams of the system for storing system for medical images according to one embodiment of the present invention.

The shown system 70 may be a computer system including input/output port, computation processor, image processor, and memory. The system 70 for storing system for medical images firstly retrieves the critical profiles apart from the non-critical profiles from the images captured by the medical modality. The system automatically discriminates the crucial and non-critical profiles from the captured images through operations made by the software modules in the system. The critical and non-critical profiles are separately stored with two different types of images for reducing the storage space. The figures shows the system 70 which retrieves the medical images from a medical modality 72 at an end, and outputs the images to the database 74 at the other end.

The system 70 is disposed with an image input module 701 used to connect with at least one medical modality. The system 70 retrieves original images captured by the medical modality from an organism body. Through a preliminary process, the original images of the organism body are firstly stored in an original image storing module 703. An image reconstruction module 705 reconstructs a three-dimensional image from the original images of the organism body. The three-dimensional image may be reconstructed by multi-planar images.

According to an embodiment of the present invention, in an initial process, one or more positioning images are created from organism body or the original images captured by the medical modality. The one or more positioning images act as references for positioning the images. For example, the system 70 is disposed with a positioning image generating module 702 for creating one or more positioning images from the original images. An examining module 704 in the system examines if the reconstructed 3D image meets malposition or other errors by the positioning images. If any malposition or error is found, the 3D image is required to be recaptured and reconstructed.

The system 70 has a preview module 706. The preview module 706 is such as a program or a preview tool for initiating a preview interface allowing the operator to preview the reconstructed three-dimensional image. An operation module 708 allows the operator to conduct preview window adjustment, image zooming, image panning, annotation, marking, or the image processing.

The system 70 has an operation signal retrieval module 707 coupled with the operation module 708 for retrieving the operation signals when the operator uses the operation module 708 to preview the three-dimensional image. The operation signals may reflect the operator's operational actions.

For acquiring the images for the critical profiles and the images for the non-critical profiles, some software instructions are required. The operation signal retrieval module 707 retrieves the various operation signals. The critical profile recording module 709 determines one or more critical profiles from the three-dimensional image based on the commands or actions in response to the operation signals. The non-critical profiles may be simultaneously retrieved as excluding the found critical profiles. Determination of the operation signals as the operator conducts previewing may be referred to the flow chart in FIG. 4.

When the system 70 retrieves the critical profiles and the non-critical profiles, the related image information is applied to the images with respect to these profiles. In an exemplary example, the system 70 assigns numbers to a series of images associated to the layers of profiles. Base on the storing tactics, a storage computing module 710 in the system 70 is used to store the images according to the image information with respect to the one or more critical profiles and non-critical profiles. For example, according to the storing tactics, the system 70 stores the original images or high-resolution images corresponding to one or more critical profiles; and store the images corresponding to the critical profiles using a streamlined scheme. According to one of the embodiment of the present invention, an image average of a series of images associated to the layers of non-critical profiles is representatively stored by the storage computing module 710.

An image output module 711 in the system 70 is used to output the original images or high-resolution images associated with the one or more critical profiles, and also the processed images associated with the non-critical profiles. The output images are stored in a database 74.

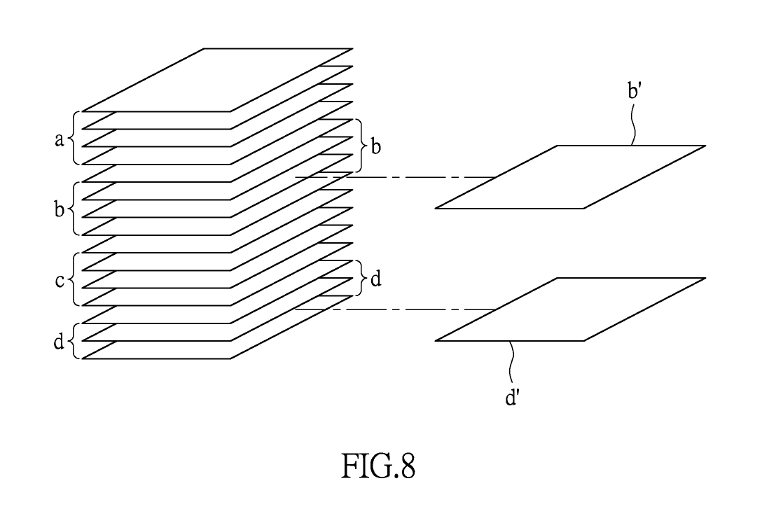

Reference is made to FIG. 8. Multi-planar images are retrieved from a portion of an organism body. The multi-planar images are used to reconstruct a three-dimensional image. When the operator previews the series of images using a preview program, the system determines the critical and non-critical profiles, and their corresponding ranges according to the operation signals. The figure appears that a segment “a” and a segment “c” are corresponding to the planar images of critical profiles. The system stores the images for both segments “a” and “c” with their original or high-resolution images. It is noted that the high-resolution images adopted by the system may not affect the medical diagnosis. The every planar image and its correlative critical profile have a correlation, e.g. index, which is provided for the system to reconstruct the 3D image in the future. The operator may accordingly retrieve the original image or high-resolution image from the critical profiles.

The rest portions of the organism body rather than the critical profiles are the critical profiles. As shown in the figure, a segment “b” and a segment “d” are corresponding to two non-critical profiles. According to storing tactics, an average may be calculated from the images in the segment “b” or the segment “d”, and stored in the database. An average represents a segment. In the diagram, a segmented image b′ and a segmented image d′ indicate the averages respectively representative of the segment b and segment d. It is noted that the shown segmented image b′ and the segmented image d′ respectively represent the critical profiles. An index is set between the image and its correlative segment, and the index is referred to reconstruct the image for future browsing. The system also allows the operator to reconstruct part of the image using the processed images for the critical profiles.

Thus, disclosure herein is related to a method and a system for storing the medical images. The system determines the portions with critical profiles and also the portions for non-critical profiles according to the operator's operations. Two different tactics are introduced to storing the images for critical profiles and the processed images for non-critical profiles. Therefore, the storage space can be effectively reduced since the non-critical profiles are stored using a streamlined scheme. By this method, the organism body still keeps the image information for further previewing.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for storing medical image, comprising:
producing a series of original images from a medical modality;
reconstructing a three-dimensional image of an organism body from the series of original images;
gaining operation signals as previewing the three-dimensional image;
in response to the operation signals determining one or more critical profiles from the series of three-dimensional image;
retrieving image information associated with the one or more critical profiles, and image information associated with the one or more non-critical profiles;
storing original or high-resolution images associated with the one or more critical profiles; and
storing processed images associated with the one or more non-critical profiles.

2. The method of claim 1, wherein the images captured by the medical modality are the original images of a series of layers of tissues of the organism body, and the three-dimensional image is reconstructed from the images of whole organism body or a portion of the organism body.

3. The method of claim 2, further comprising retrieving one or more positioning images from the original images, and examining the reconstructed image by the one or more positioning images.

4. The method of claim 3, wherein the one or more positioning images are one or more profile images from the organism body in one or more directions, and are used to be the positioning images for examining malposition as reconstructing the three-dimensional image.

5. The method of claim 2, wherein, setting a storing range of each critical profile when retrieving images of the one or more critical profiles, and storing original or high-resolution images of the one or more critical profiles according to the set storing range.

6. The method of claim 5, wherein, retrieving the one or more non-critical profiles when excluding the storing ranges of the one or more critical profiles, and storing the images with respect to each non-critical profile in accordance with a streamlined scheme.

7. The method of claim 6, wherein the streamlined scheme is to store an average of images of a series of layers of each non-critical profile.

8. The method of claim 1, further comprising retrieving one or more positioning images from the original images, and examining the reconstructed image by the one or more positioning images.

9. The method of claim 8, wherein the one or more positioning images are one or more profile images from the organism body in one or more directions, and are used to be the positioning images for examining malposition as reconstructing the three-dimensional image.

10. A system for performing a method for storing medical image, wherein the method performed by the system comprises:
producing a series of original images from a medical modality;
reconstructing a three-dimensional image of an organism body from the series of original images;
gaining operation signals as previewing the three-dimensional image;
in response to the operation signals determining one or more critical profiles from the series of three-dimensional image;
retrieving image information associated with the one or more critical profiles, and image information associated with the one or more non-critical profiles;
storing original or high-resolution images associated with the one or more critical profiles; and
storing processed images associated with the one or more non-critical profiles.

11. The system of claim 10, wherein the images captured by the medical modality are the original images of a series of layers of tissues of the organism body, and the three-dimensional image is reconstructed from the images of whole organism body or a portion of the organism body.

12. A system for storing medical image, comprising:
an image input module, connected with at least one medical modality, used to retrieve original images captured from an organism body by the at least one medical modality;
an original image storing module, storing original images of the organism body;
an image reconstruction module, reconstructing a three-dimensional image when the original image from the organism body are retrieved;
a preview module, providing an operating interface for reviewing the three-dimensional image;
an operation signal retrieval module, receiving operation signals generated when an operation module is used to preview the three-dimensional image;
a critical profile recording module, determining one or more critical profiles from the three-dimensional image according to the operation signals, and retrieving one or more non-critical profiles as excluding the critical profiles;
a storage computing module, generating original images associated with the one or more critical profiles and processed images associated with the one or more non-critical profiles after retrieving image information associated with the one or more critical profiles and one or more non-critical profiles;
an image output module, outputting original or high-resolution images associated with the one or more critical profiles, and the processed images associated with one or more non-critical profiles, and storing the images for both the one or more critical and non-critical profiles to a database.

13. The system of claim 12, further comprising:
a positioning image generating module, retrieving one or more positioning images from the original images of the organism body; and
an examining module, examining if any malposition occurs by the one or more positioning images as reconstructing the three-dimensional image.

14. The system of claim 12, wherein the operation signal retrieval module retrieves operation signals from the operation module when an operator previews the images using an operating interface of the preview module; wherein the operation made as previewing the every image by the operator is one of the following operations: adjusting the window, image panning, image zooming, annotating, image management, key noting, and staying for a while.
